(19) United States
(12) Patent Application Publication
(10) Pub. No.: US 2016/0156691 A1
(43) Pub. Date: Jun. 2, 2016

(54) Session Awareness for Communication Sessions

(71) Applicant: Microsoft Technology Licensing, LLC, Redmond, WA (US)

(72) Inventors: Gunter Leeb, Redmond, WA (US); Timothy M. Moore, Bellevue, WA (US); Danny Levin, Herzliya (IL)

(21) Appl. No.: 14/557,065

(22) Filed: Dec. 1, 2014

(51) Int. Cl. H04L 29/06; H04L 29/08

(52) U.S. Cl. CPC H04L 65/80; H04L 67/14; H04L 65/1083; H04L 67/146

(57) ABSTRACT

Techniques for session awareness for communication sessions are described. According to various embodiments, a network adviser system is leveraged to aggregate session awareness of a communication session, and to propagate the session awareness among various networks involved in routing the communication session. Such session awareness enables networks involved in routing communication sessions to make informed decisions regarding routing and handling of communication session data.

### BACKGROUND

Modern communication systems have an array of capabilities, including integration of various communication modalities with different services. For example, instant messaging, voice/video communications, data/application sharing, white-boarding, and other forms of communication may be combined with presence and availability information for subscribers. Such systems may provide subscribers with the enhanced capabilities such as providing instructions to callers for various status categories, alternate contacts, calendar information, and comparable features. Furthermore, collaboration systems enabling users to share and collaborate in creating and modifying various types of documents and content may be integrated with multimodal communication systems providing different kinds of communication and collaboration capabilities. Such integrated systems are sometimes referred to as Unified Communication and Collaboration (UC&C) systems.

While UC&C systems provide for increased flexibility in communications, they also present a number of implementation challenges. For instance, a UC&C system typically utilizes multiple interconnected networks to route various communications. Since different networks may be managed by different entities, challenges thus arise in managing communications quality for communications that are routed among independently managed networks. Further, UC&C is typically implemented via software that can be loaded on mobile devices, e.g., tablets, smartphones, laptops, and so forth. Thus, techniques for managing UC&C communication traffic typically have to be fluid and dynamic to accommodate changing connection scenarios.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for session awareness for communication sessions are described. According to various embodiments, a network adviser system is leveraged to aggregate session awareness of a communication session, and to propagate the session awareness among various networks involved in routing the communication session. Such session awareness enables networks involved in routing communication sessions to make informed decisions regarding routing and handling of communication session data.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein.

FIG. 2 illustrates an example implementation scenario for aggregating session awareness in accordance with one or more embodiments.

FIG. 3 illustrates an example implementation scenario for propagating session awareness in accordance with one or more embodiments.

FIG. 4 illustrates an example implementation scenario for propagating session awareness of a session termination in accordance with one or more embodiments.

FIG. 5 is a flow diagram that describes steps in a method for causing aggregation of session awareness in accordance with one or more embodiments.

FIG. 6 is a flow diagram that describes steps in a method for receiving session awareness in accordance with one or more embodiments.

FIG. 7 is a flow diagram that describes steps in a method for aggregating and disseminating session awareness in accordance with one or more embodiments.

FIG. 8 is a flow diagram that describes steps in a method for verifying access to session awareness in accordance with one or more embodiments.

FIG. 9 is a flow diagram that describes steps in a method for allowing access to session awareness in accordance with one or more embodiments.

FIG. 10 is a flow diagram that describes steps in a method for negotiating for a trusted network adviser in accordance with one or more embodiments.

FIG. 11 illustrates an example system and computing device as described with reference to FIG. 1, which are configured to implement embodiments of techniques described herein.

### DETAILED DESCRIPTION

Overview

Techniques for session awareness for communication sessions are described. In at least some embodiments, a communication session refers to a real-time exchange of communication media between different communication endpoints. Examples of a communication session include a Voice over Internet Protocol (VoIP) call, a video call, text messaging, a file transfer, content sharing, and/or combinations thereof. In at least some embodiments, a communication session represents a Unified Communication and Collaboration (UC&C) session.

According to various implementations, a network adviser system is leveraged to aggregate session awareness of a communication session, and to propagate the session awareness among various networks involved in routing the communication session. Generally, session awareness includes attributes of the communication session, such as identifiers for endpoints involved in the communication session, identifiers for different autonomous networks involved in routing the communication session, performance attributes (e.g., session quality) across the different autonomous networks, and so forth. Session awareness, for instance, is propagated out-of-band from a data stream that carries the communication session. Thus, propagation of session awareness for a communication session may be independent from the communication session

According to various implementations, session awareness for a communication session can be aggregated by the network adviser system from different autonomous networks, and propagated by the network adviser system among the autonomous networks. For instance, the network adviser system interfaces with network controllers for different networks to receive session awareness from the network controllers, and disseminate session awareness among the network controllers. Thus, a particular network controller may not only be aware of attributes and conditions of its own respective network, but may be informed of attributes and conditions of other networks involved in a communication session.

Thus, techniques discussed herein provide diverse scenarios for enlightening different autonomous networks with session awareness. Such session awareness enables entities involved in routing communication sessions to make informed decisions regarding routing and handling of communication session data. For instance, session awareness may be leveraged to optimize session performance, optimize network performance, mitigate session errors, and so forth.

In the following discussion, an example environment is first described that is operable to employ techniques described herein. Next, a section entitled “Propagating Session Awareness” discusses some example ways for propagating session awareness in accordance with one or more embodiments. Following this, a section entitled “Example Implementation Scenarios” describes some example implementation scenarios in accordance with one or more embodiments. Next, a section entitled “Example Procedures” describes some example procedures in accordance with one or more embodiments. Following this, a section entitled “Example Actions” describes some example actions that can be taken based on session awareness in accordance with one or more embodiments. Finally, a section entitled “Example System and Device” describes an example system and device that are operable to employ techniques discussed herein in accordance with one or more embodiments.

Having presented an overview of example implementations in accordance with one or more embodiments, consider now an example environment in which example implementations may by employed.

Example Environment

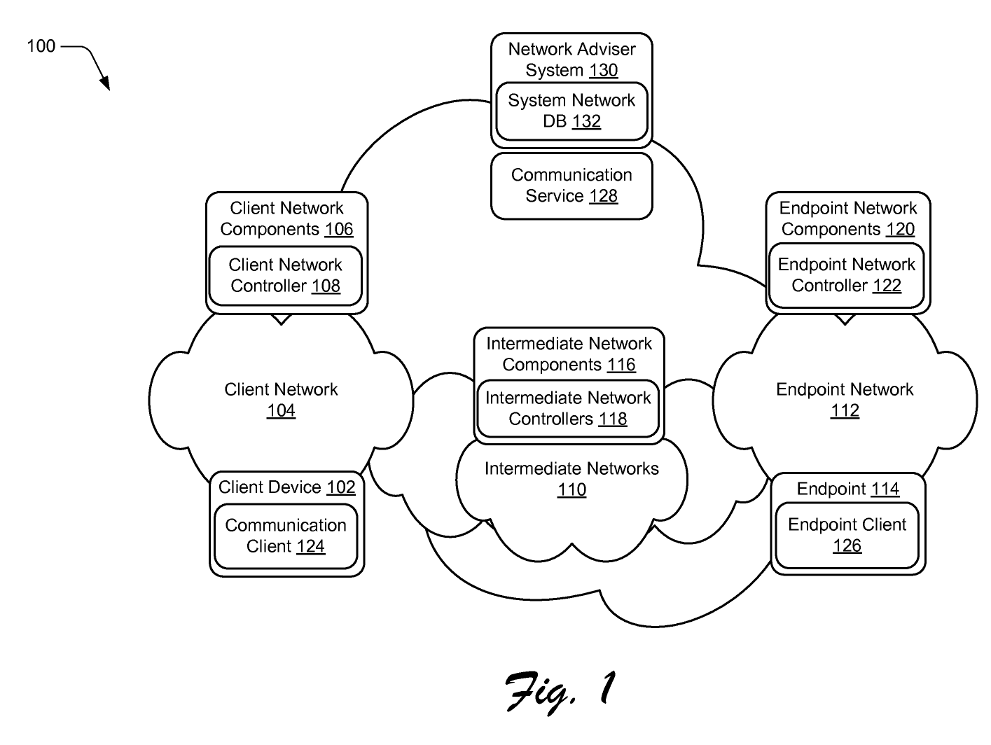

FIG. 1 is an illustration of an environment 100 in an example implementation that is operable to employ techniques for session awareness for communication sessions described herein. Generally, the environment 100 includes various devices, services, and networks that enable communication via a variety of different modalities. For instance, the environment 100 includes a client device 102 connected to a client network 104. The client device 102 may be configured in a variety of ways, such as a traditional computer (e.g., a desktop personal computer, laptop computer, and so on), a mobile station, an entertainment appliance, a smartphone, a wearable device, a netbook, a game console, a handheld device (e.g., a tablet), and so forth.

The client network 104 is representative of a network that provides the client device 102 with connectivity to various networks and/or services, such as the Internet. The client network 104 may be provided and/or managed by a particular enterprise entity, such as an Internet Service Provider (ISP). For instance, the client network 104 represents a local access provider (LAP) network that provides the client device 102 with network connectivity. The client network 104 may provide the client device 102 with connectivity via a variety of different connectivity technologies, such as broadband cable, digital subscriber line (DSL), wireless cellular, wireless data connectivity (e.g., WiFi™), T-carrier (e.g., T1), Ethernet, and so forth.

The client network 104 includes client network components 106, which are representative of different infrastructure components of the client network 104, such as hardware and logic for implementing and maintaining the client network 104. Examples of the client network components 106 include network switches, routers, gateways, network elements, and so forth. The client network components 106, for instance, include a client network controller 108. The client network controller 108 is representative of functionality to manage various aspects of the client network 104, such as connectivity and routing for the client network components 106.

According to various implementations, the client network controller 108 maintains state awareness of the various client network components 106. For example, the client network controller 108 maintains a mapping of the client network components 106 (e.g., in terms of location) and performance attributes of the client network components 106, such as signal quality, quality of service (QoS) attributes, and so forth.

The client network controller 108, for instance, includes connectivity and logic that accesses routing information for the client network components 106. For example, the client network controller 108 can access an Interior Gateway Protocol (IGP) and/or spanning tree switching topology for the client network components 106. This enables the client network controller 108 to identify different data routing paths within the client network 104, and to map and remap the different routing paths.

Connected to the client network 104 are intermediate networks 110, which in turn are connected to an endpoint network 112. The intermediate networks 110 and the endpoint network 112 are representative of different types and instances of wired and wireless networks that may be implemented and managed by different respective entities and according to a variety of different networking technologies, such as such as broadband cable, digital subscriber line (DSL), wireless cellular, wireless data connectivity (e.g., WiFi™), T-carrier (e.g., T1), Ethernet, and so forth.

According to various implementations, connectivity between the client network 104, the intermediate networks 110, and the endpoint network 112 provides different communication paths between the client device 102 and an endpoint 114. The endpoint 114 is representative of devices and/or functionalities with which the client device 102 may communicate.

The intermediate networks 110 include intermediate network components 116, which in turn include intermediate network controllers 118. Generally, the intermediate network components 116 are representative of different infrastructure components of the intermediate networks 110, such as hardware and logic for implementing and maintaining the intermediate networks 110. The intermediate network controllers 118 are representative of functionalities to manage various aspects of the intermediate networks 110, such as connectivity and routing of the intermediate network components 116. According to various implementations, one or more of the intermediate network components 116 interface with one or more of the client network components 106 to provide peering points between the client network 104 and the intermediate networks 110.

The endpoint network 112 includes endpoint network components 120, which in turn include an endpoint network controller 122. Generally, the endpoint network controller 122 is representative of functionality to manage various aspects of the endpoint network 112, such as connectivity and routing for the endpoint network components 120. For instance, one or more of the intermediate network components 116 interface with one or more of the endpoint network components 120 to provide peering points between the endpoint network 112 and the intermediate networks 110. Example attributes and aspects of the endpoint network components 120 are discussed above with reference to the client network components 106.

According to various implementations, communication between the client device 102 and the endpoint 114 is facilitated via a communication client 124 of the client device 102, and a communication client 126 of the endpoint 114. Generally, the communication clients 124, 126 are representative of functionalities to enable different forms of communication via the client device 102 and the endpoint 114. Examples of the communication clients 124, 126 include a voice communication application (e.g., a VoIP client), a video communication application, a messaging application, a content sharing application, and combinations thereof. The communication clients 124, 126 for instance, enable different communication modalities to be combined to provide diverse communication scenarios.

In at least some implementations, the communication clients 124, 126 represent interfaces to a communication service 128. Generally, the communication service 128 is representative of a service to perform various tasks for management of communication between the client device 102 and the endpoint 114. The communication service 128, for instance, can manage initiation, moderation, and termination of communication sessions between the communication clients 124, 126.

The communication service 128 maintains a presence across many different networks and can be implemented according to a variety of different architectures, such as a cloud-based service, a distributed service, a web-based service, and so forth. Examples of the communication service 128 include a VoIP service, an online conferencing service, a UC&C service, and so forth. In at least some embodiments, the communication service 128 may be implemented as or be connected to a private branch exchange (PBX) in communication with a Public Switched Telephone Network (“PSTN”) to enable voice communication between the client device 102 and other endpoints, such as the endpoint 114.

Further to techniques for session awareness for communication sessions discussed herein, the environment 100 includes a network adviser system 130. Generally, the network adviser system 130 is representative of functionality to aggregate and disseminate session awareness. “Session awareness,” for instance, refers to information pertaining to specific instances of communication sessions, networks involved in routing communication sessions, users that participate in communication sessions, and so forth. Various examples of session awareness are detailed below.

According to various implementations, the network adviser system 130 interfaces with the client network controller 108 of the client network 104, the intermediate network controllers 118 of the intermediate networks 110, and the endpoint network controller 122 of the endpoint network 112. The network adviser system 130 can receive session awareness from the different network controllers, and can expose session awareness to the different network controllers to enable the individual networks to maintain state awareness of attributes of a communication session and thus make intelligent decisions to optimize communication session performance. In at least some implementations, the network controllers include logic that is deployed in the different network controllers as agents of the network adviser system 130. For instance, the respective network controllers may include an Application Programming Interface (API) to enables interaction and data exchange between the network adviser system 130 and the network controllers.

Unless one of the client network controller 108, the intermediate network controllers 118, or the endpoint network controller 122 is specifically referenced, the term “network controller” as used herein may refer to one or all of the client network controller 108, the intermediate network controllers 118, or the endpoint network controller 122.

According to one or more implementations, the network adviser system 130 may be implemented and/or maintained by the communication service 128, such as to aggregate and propagate session awareness for communication sessions managed by the communication service 128. Alternatively, the network adviser system 130 may be implemented separately and/or independently from the communication service 128. The network adviser system 130, for instance, may aggregate and propagate session awareness for different entities and/or systems involved in communication sessions, such as different communication clients and communication services.

According to one or more implementations, the network adviser system 130 maintains a system network database (DB) 132, which is representative of functionality to track various information pertaining to the different networks of the environment 100. For example, the system network DB 132 maintains active state awareness of network attributes of the client network 104, the intermediate networks 110, and the endpoint network 112. Examples of such network attributes include performance attributes, such as current and historical performance attributes of communication sessions across the different networks. Network attributes include various other types of information, such as identifiers for different networks, network mappings, network configurations and capabilities, and so forth.

The system network DB 132 may also track session awareness for various current and historical communication sessions, such as identifiers for individual communication sessions, endpoints involved in individual communication sessions, networks through which individual communication sessions are routed, and so forth. As further detailed herein, session awareness pertaining to a communication session can be propagated out-of-band from data of the communication session itself Thus, decisions concerning handling and routing of communication session data may be made independent of processing and/or handling the actual communication session data.

In at least some implementations, session awareness pertaining to communication sessions and network conditions can be propagated among the different network controllers to provide end-to-end awareness of conditions affecting a communication session. For instance, session may be propagated from the individual network controllers to the network adviser system 130, which may aggregate the information as part of the system network DB 132. The network adviser system 130 may share this session awareness among the different networks to enable session awareness to be propagated to entities involved in routing and handling communication sessions. Thus, a particular network may not only have session awareness of its own particular network conditions, but may also be enlightened with session awareness of network conditions for other networks involved in communication sessions.

Generally, the client network 104, the individual intermediate networks 110, and the endpoint network 112 each represent individual autonomous networks that connect with each other via their respective peering points, e.g., gateways, edge routers, and so forth. The different networks, for instance, may be implemented and managed by different entities, such as different infrastructure and service providers. Thus, implementations discussed herein provide for a variety of different environments in which session awareness may be propagated among different autonomous networks involved in routing and/or handling communication sessions.

Having described an example environment in which the techniques described herein may operate, consider now a discussion of example ways of propagating various attributes of communication sessions in communication systems in accordance with one or more embodiments.

Propagating Session Awareness

According to various embodiments, techniques can be employed to dynamically enlighten various entities with session awareness, such as information about communication sessions, information about network configuration, information about network conditions, and so forth. For instance, notification events can be generated that include various attributes of communication sessions and network conditions. The notification events can be propagated to different entities further to techniques for session awareness for communication sessions discussed herein.

In at least some embodiments, notification events can be configured using a communication application programming interface (API) that can be leveraged to configure and communicate session awareness. For example, the communication API can identify dialogue events and session events for which attributes of a communication session and/or network conditions can be identified. Consider, for instance, the following events and attributes that may be conveyed via a notification event generated using the communication API. Generally, the events and attributes represent types and instances of session awareness information.

Dialogue Events—These events apply to various portions of a communication session, such as the start, update, and end of a communication session. A dialogue event can include one or more of the following example attributes.

(1) Network Identifier: This attribute can be leveraged to identify a network, such as a network from which a dialogue event is received. In at least some implementations, the network identifier may include an autonomous system (AS) number that identifies a particular network. With reference to the environment 100, for instance, the network identifier may identify the client network 104, an intermediate network 110, and/or the endpoint network 112.

(2) Timestamp: This attribute can be leveraged to specify timestamps for various portions of a communication session, such as a start of a communication session, updates that occur during a communication session, an end (e.g., termination) of a communication session, and so forth.

(3) Source IP Address: This attribute can be leveraged to specify an IP address for a device that is a source of media during a communication session, e.g., a device that initiates a communication session. With reference to the environment 100, for instance, the source IP address may be for the client device 102 or the endpoint 114.

(4) Destination IP Address: This attribute can be leveraged to specify an IP address for a device that is to receive media as part of a communication session. With reference to the environment 100, for instance, the destination IP address may be for the client device 102 or the endpoint 114.

(5) Transport Type: This attribute can be leveraged to specify a transport type or combination of transport types for a communication session. Examples of transport types include Transmission Control Protocol (TCP), User Datagram Protocol (UDP), and so forth.

(6) Source Port: this attribute can be leveraged to specify an identifier for a port at a source device, e.g., a source device identified by the Source IP Address referenced above.

(7) Destination Port: This attribute can be leveraged to specify an identifier for a port at a destination device, e.g., a destination device identified by the Destination IP Address referenced above.

(8) Media Type: This attribute can be leveraged to specify a media type and/or types that are to be transmitted and/or are being transmitted as part of a communication session. As discussed elsewhere herein, the communication session can involve multiple different types of media. Thus, the Media Type attribute can be employed to identify media types in a communication session, such as for applying the service policies discussed herein.

(9) Bandwidth Estimation: This attribute can be leveraged to specify an estimated bandwidth that is to be allocated for a communication session. The estimated bandwidth, for instance, can be based on various factors, such as a privilege level associated with a user, type and/or types of media included in a communication session, and so forth.

(10) To: This attribute can be leveraged to identify a user to which media in a communication session is to be transmitted.

(11) From: This attribute can be leveraged to identify a user from which media in a communication session is transmitted.

(12) Codec: This attribute can be leveraged to specify a codec or codecs utilized as part of a communication session.

(13) Quality of Service (QoS): This attribute can be leveraged to specify QoS markings/tags to be applied to data of a communication session. Examples of different QoS include best effort (BE), expedited forwarding (EF), assured forwarding (AF), and so forth.

(14) Error Code: This attribute can be leveraged to specify various error codes for errors that may occur as part of a communication session. For example, errors can include errors that occur during initiation the communication session, errors that occurred during a communication session, errors that occur when a communication session is terminated, and so forth.

Session Problem Events—These events can be generated and applied when a communication session experiences errors, performance degradation, and so forth. A session problem event may include one or more of the attributes discussed above with reference to Dialogue Events, and may also include one or more of the following attributes.

(1) Mean Opinion Score (MOS) Degradation: This attribute can be leveraged to specify a MOS for a communication session. The attribute, for instance, can be used to indicate that an overall quality of a communication session has decreased.

(2) Jitter Inter-Arrival Time: This attribute can be leveraged to specify jitter values for a communication session. The attribute, for instance, can be used to indicate that a jitter value or values have increased, e.g., have exceeded a specified jitter value threshold.

(3) Packet Loss Rate: This attribute can be leveraged to specify a packet loss rate for a communication session. The attribute, for instance, can be used to indicate that a packet loss rate has increased, e.g., has exceeded a specified packet loss rate value threshold.

(4) Round Trip Delay (RTD): This attribute can be leveraged to specify RTD values for packets in communication sessions. The attribute, for instance, can be used to indicate that RTD values for packets have increased, e.g., have exceeded a specified RTD value threshold.

(5) Concealment Ratio: This attribute can be leveraged to specify a cumulative ratio of concealment time over speech time observed after starting a communication session. The attribute, for instance, can be used to specify that a concealment ratio has increased, e.g., has exceeded a specified concealment ratio value threshold.

Thus, various notifications discussed herein can include one or more of the attributes discussed above and can be used to propagate session awareness to various entities. In at least some implementations, attributes can be linked to particular networks and/or network components to characterize performance attributes of the networks and/or network components.

Having described an example ways of propagating session awareness, consider now some example implementation scenarios for session awareness for communication sessions in accordance with one or more embodiments.

Example Implementation Scenarios

The following section describes example implementation scenarios for session awareness for communication sessions in accordance with one or more implementations. The implementation scenarios may be implemented in the environment 100 discussed above, and/or any other suitable environment.

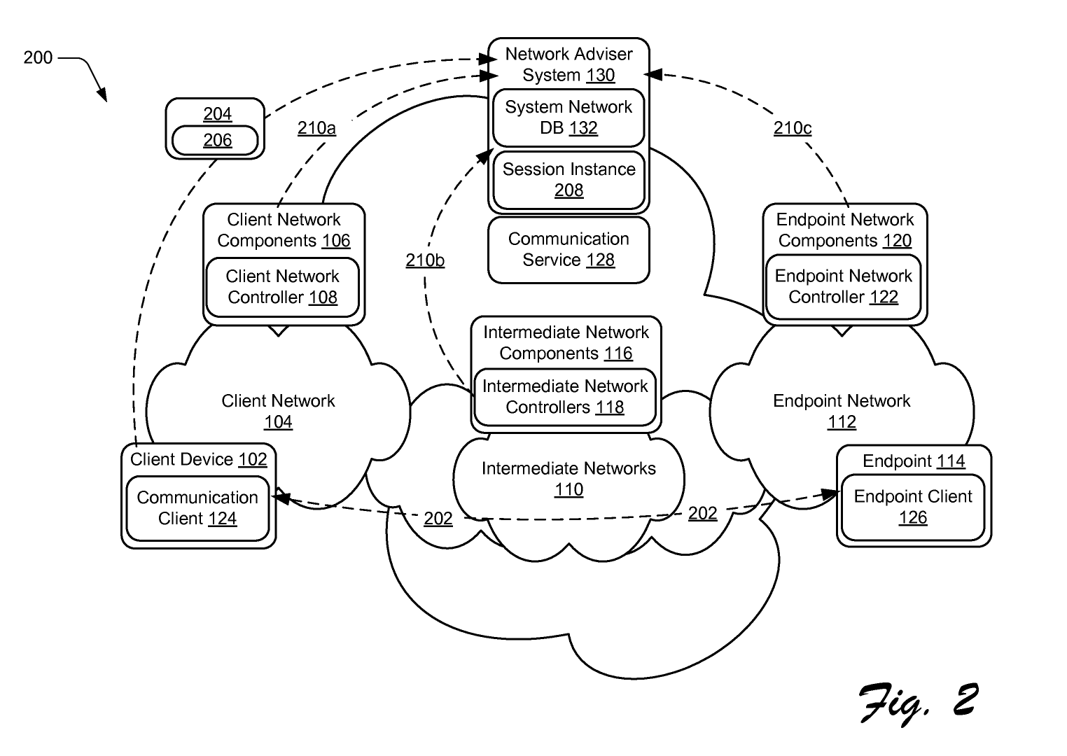

FIG. 2 illustrates an example implementation scenario 200 for aggregating session awareness in accordance with one or more implementations. The scenario 200 includes various entities and components introduced above with reference to the environment 100.

In the scenario 200, a user authenticates the client device 102 with the communication service 128 via the communication client 124. The user then enters a request to initiate a communication session with the endpoint 114. For instance, the user selects an indicia indicating a request to initiate a communication session, such as by entering a phone number for the endpoint 114, selecting a contact from a contact list, selecting a hyperlink that points to the endpoint 114, and so forth.

In response to the request to initiate the communication session, a communication session 202 is established between the communication client 124 of the client device 102, and the endpoint client 126 of the endpoint 114. According to various implementations, a routing path for routing the communication session is selected using any suitable algorithm, such as a shortest path algorithm applied by the client network controller 108, the intermediate network controllers 118, and/or the endpoint network controller 122. In at least some embodiments, the routing path is derived based on a particular routing protocol, such as Border Gateway Protocol (BGP).

Further in response to the request to initiate the communication session 202, the communication client 124 sends a start session event 204 to the network adviser system 130. The start session event 204 includes parameters of the communication session 202, such as an identifier for the client device 102, an identifier for the endpoint 114, and so forth. For instance, the start session event 204 includes a session identifier 206 that uniquely identifies the communication session 202. Attributes of the communication API referenced above, for example, can be used to format the start session event 204 and communicate the session identifier 206 along with attributes of the communication session 202, attributes of the client network 104, and so forth.

According to various implementations, the start session event 204 may be communicated at various points in relation to the communication session 202, such as prior to, concurrently with, and/or subsequent to initiation of the communication session 202.

In response to receiving the start session event 204, the network adviser system 130 creates a session instance 208 for the communication session 202 and populates the session instance 208 with information from the start session event 204. Generally, the session instance 208 corresponds to a session record that is leveraged to track various information for the communication session 202, such as the session identifier 206, identifiers for the client device 102 and the endpoint 114, attributes of networks involved in the communication session 202, as well as various other information pertaining to the communication session 202. As further detailed below, the session instance 208 can be dynamically updated to reflect various state changes that occur at different stages of the communication session 202.

Continuing with the scenario 200, the session identifier 206 is communicated along with data of the communication session 202. The session identifier 206, for example, is communicated in-band with the communication session 202. For instance, the session identifier 206 may be linked to and/or embedded within data of the communication session 202 in various ways. In a scenario where the communication session 202 is implemented as a Real-time Transport Protocol (RTP) stream, for example, the session identifier 206 may be embedded in the RTP header. As another example, the session identifier may be sent as part of RTP Control Protocol (RTCP) data for the communication session 202. In a further example, the session identifier 206 may be sent as part of an Interactive Connectivity Establishment (ICE)-related message, such a connectivity ping message related to the communication session 202. These options are presented for purpose of example only, and it is to be appreciated that the session identifier 206 may be communicated in a variety of different ways in accordance with the claimed embodiments.

According to one or more implementations, the data stream of the communication session 202 may be encrypted such that entities external to the client device 102 and the endpoint 114 cannot view data of the communication session in-the-clear. For instance, the client device 102 and the endpoint 114 may maintain cryptographic keys for encrypting and decrypting data of the communication session 202. The session identifier 206, however, may be transmitted in an unencrypted form such that entities along the routing path of the communication session 202 can read and utilize the session identifier 206, such as for retrieving session awareness. This is not intended to be limiting, however, and in at least some implementations, the session identifier 206 may be communicated in an encrypted form. For instance, different network controllers along the routing path of the communication session 202 may maintain cryptographic keys that may be utilized to decrypt an encrypted form of the session identifier 206.

In at least some implementations, the session identifier 206 may include and/or be accompanied by an identifier for the network adviser system 130, such as a Uniform Resource Indicator (URI), a Uniform Resource Locator (URL), and so forth, that points to the network adviser system 130. Various entities that interact with the network adviser system 130 (e.g., a network controller) may utilize the identifier to access and/or interact with the network adviser system 130.

As illustrated, the communication session 202 traverses the client network 104, one or more intermediate networks 110, and the endpoint network 112 to reach the endpoint 114. Thus, in response to detecting the session identifier 206, networks controllers for the different networks can perform various actions. The session identifier 206, for example, may represent a trigger event for causing various actions to be initiated. For instance, the client network controller 108 detects the session identifier 206 and communicates a session registration event 210a to the network adviser system 130. Generally, the session registration event 210a includes information about the network path that the communication session 202 traverses across the client network 104. For instance, the session registration event 210a identifies client network components 106 that the communication session 202 traverses on its way to the intermediate networks 110. The session registration event 210a may include various attributes of the client network components 106, such as device configuration, capabilities, settings, performance attributes (e.g., signal quality across individual components), and so forth.

In at least some implementations, the session registration event 210a may include authentication information for authenticating with the network adviser system 130. For example, the network adviser system 130 may implement an authentication procedure prior to allowing the client network controller 108 to access functionality and services provided by the network adviser system 130. Thus, the session registration event 210a may include authentication information, such as a username (e.g., a network name), a password, and/or other suitable authentication factor(s).

Continuing with the scenario 200, the network adviser system 130 detects the session identifier 206 in the session registration event 210a, and thus ascertains that the client network 104 is involved in the communication session 202. Accordingly, the network adviser system 130 populates information from the session registration event 210a to the session instance 208, such as an identifier for the client network 104, attributes of the client network components 106, performance attributes of the communication session 202 across the client network 104, and so forth.

In a similar manner as the client network controller 108, the intermediate network controllers 118 detect the session identifier 206 and thus communicate session registration events 210b to the network adviser system 130. For instance, individual of the intermediate network controllers 118 each communicate a different instance of the session registration events 210b to the network adviser system 130. Generally, the session registration events 210b may include similar information and attributes for the intermediate networks 110 as the session registration event 210a includes for the client network 104, examples of which are detailed above. Thus, network adviser system 130 populates the session instance 208 with information from the session registration events 210b.

Continuing with the scenario 200, the endpoint network controller 122 detects the session identifier 206 and thus communicates a session registration event 210c to the network adviser system 130. Generally, the session registration event 210c may include similar information and attributes for the endpoint network 112 as the session registration event 210a includes for the client network 104, examples of which are detailed above. Accordingly, the network adviser system 130 populates the session instance 208 with information from the session registration event 210c.

According to various implementations, the session instance 208 now has session awareness information that describes various attributes of a path that the communication session 202 traverses from the client device 102 to the endpoint 114. The session instance 208, for example, identifies networks, network components, network performance attributes, session performance attributes, and so forth, for networks that the communication session 202 traverses. Examples of performance attributes include available bandwidth, packet error rate, jitter, packet loss rate, and so forth, observed for the communication session 202 across the different networks. As further detailed below, information from the session instance 208 may be propagated among various entities involved in the communication session 202 to enable various actions to be taken, such as for optimizing session performance.

According to various implementations, the session instance 208 may include an end-to-end description of the network path that the communication session 202 travels between the client device 102 and the endpoint 114. In at least some implementations, however, a particular network (e.g., an intermediate network 110) may not support interaction with the network adviser system 130. The particular network, for instance, may not have a network controller that includes functionality for interacting with the network adviser system 130. Thus, the particular network may be unable to directly communicate its attributes to the network adviser system 130. For purposes of the discussion herein, such a network is referred to as a “non-supportive network.”

In such a case, various techniques may be employed to ascertain attributes of a non-supportive network and communicate the attributes to the network adviser system 130. For instance, a network controller for an adjacent network (e.g., the client network controller 108 and/or the endpoint network controller 122) may use network probing techniques to ascertain network attributes of a non-supportive network. Examples of such attributes include attributes of network components of a non-supportive network, such as component types, component identifiers (e.g., make, model, and so forth), component performance attributes, and so forth. The network attributes may additionally or alternatively include performance statistics for a non-supportive network, such as signal quality, bandwidth, and so forth, across the network. A network controller that ascertains such attributes of a non-supportive network may then communicate the attributes to the network adviser system 130 to be included in the session instance 208.

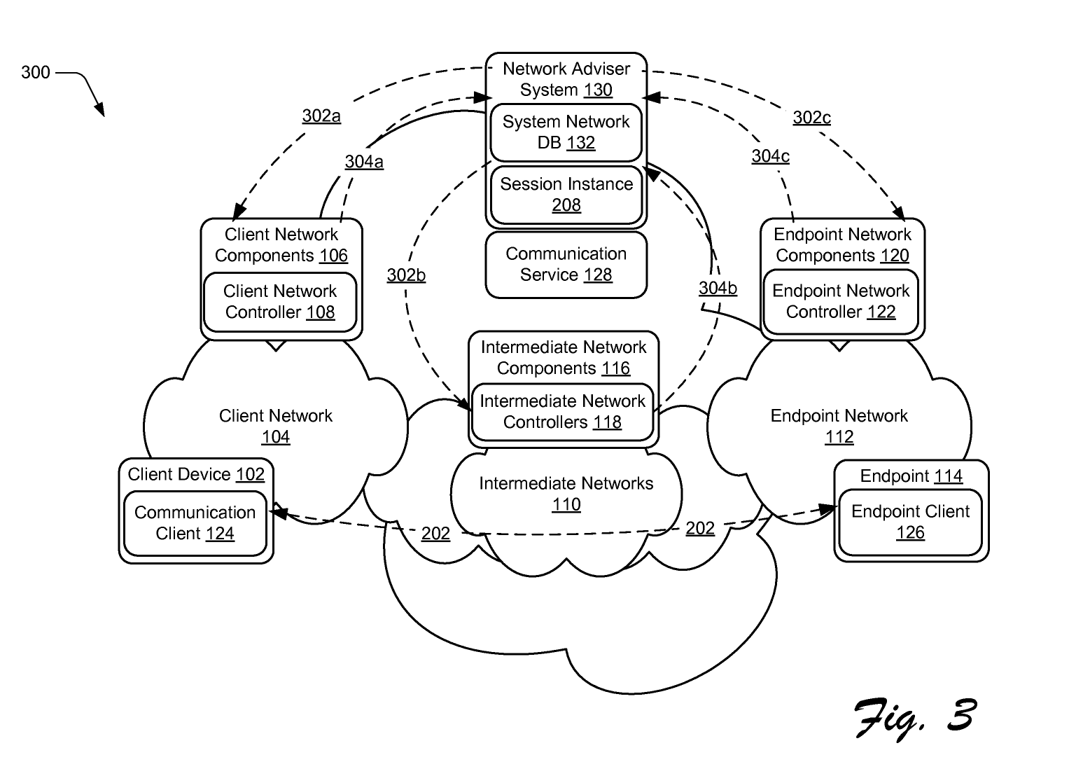

FIG. 3 illustrates an example implementation scenario 300 for propagating session awareness in accordance with one or more implementations. The scenario 300 includes various entities and components introduced above with reference to the environment 100. In at least some implementations, the scenario 300 represents an extension of the scenario 200 discussed above. For instance, aspects of the scenarios 200 and 300 may occur as part of a single communication session, e.g., while the communication session 202 is in progress.

In the scenario 300, information from the session instance 208 (e.g., session awareness information) is propagated among networks involved in the communication session 202. For instance, a notification event 302a is communicated to the client network controller 108, notification events 302b are communicated to the intermediate network controllers 118, and a notification event 302c is communicated to the endpoint network controller 122. Generally, the notification events 302a, 302b, 302c include information from the session instance 208, examples of which are detailed above. According to various implementations, the notification events 302a, 302b, 302c may be pushed to the respective network controllers by the network adviser system 130 and independent of a query from the network advisers. Alternatively or additionally, the notification events 302a, 302b, 302c may be communicated to the network controllers in response to a query from one or more of the network controllers.

In at least some implementations, the notification events 302a, 302b, 302c include identical information. For example, notification events 302a, 302b, 302c may include some or all of the information aggregated within the session instance 208 from the different networks. Alternatively, the notification events 302a, 302b, 302c may include different respective sets of information from the session instance 208. For instance, different network controllers may have different privilege levels that specify types of information that the network adviser system 130 may provide to the respective network controllers.

Consider, for example, that the client network controller 108 and the endpoint network controller 122 are permitted to obtain identification information for users of the client device 102 and/or the endpoint 114. The intermediate network controllers 118, however, may not be permitted to obtain such user identification information. Thus, the notification event 302a and/or the notification event 302c may include user identification information, whereas such user identification information may be omitted from the notification events 302b. Accordingly, different networks may have different access permission levels that specify different levels of access to information of the session instance 208. Thus, the network adviser system 130 may distribute varying sets of information to the different network controllers according to respective permission levels for the individual network controllers.

Continuing with the scenario 300, the client network controller 108 communicates an update event 304a to the network adviser system 130, the intermediate network controllers 118 communicate update events 304b to the network adviser system 130, and the endpoint network controller 122 communicates an update event 304c to the network adviser system 130. Generally, the update events 304a, 304b, 304c include updates to various state attributes of the communication session 202 and/or updates to state attributes of the different networks. A particular update event, for instance, can indicate a session problem with the communication session 202, such as a signal quality problem detected in one or more of the networks. As another example, an update event may indicate a state change in a particular network, such as a change in network component attributes, a change in routing path attributes, and so forth. Generally, an update event reflects a change in session and/or network state that occurs after a communication session is initiated.

Further to the scenario 300, information from the update events 304a, 304b, 304c is used to update the session instance 208. For example, information in the session instance 208 may be replaced and/or augmented with information from the update events 304a, 304b, 304c. In at least some implementations, an update event may be communicated to the network adviser system 130 in response to various events, such as a state change in the communication session 202, a state change in a network, an indication of session problems and/or of network problems within a particular network, and so forth. Alternatively or additionally, an update event may be sent periodically, such as according to an update time interval. For instance, an update event may be sent by one or more of the network controllers every n milliseconds. Thus, the session instance 208 may be dynamically updated to reflect changes in session state, changes in network state, and so forth.

Accordingly, the session instance 208 may reflect up-to-date state information that pertains to and/or affects the communication session 202. According to various implementations, the network adviser system 130 may propagate further notification events to the network controllers that reflects a change to the session instance 208 based on the update events 304a, 304b, 304c. Thus, the network controllers may be notified of changes that occur across a routing path for the communication session 202. In at least some implementations, notification events that include information from the session instance 208 may be communicated to the network controllers at various stages of the communication session 202, such prior to initiation, as part of session initiation, while the session is in progress, as part of a session termination event, after the communication session 202 has terminated, and so forth. Thus, the different network controllers may maintain up-to-date state information for the communication session 202 via interaction with the network adviser system 130.

According to various implementations, the network controllers may perform various actions based on session awareness received from the network adviser system 130. Examples of such actions are provided below.

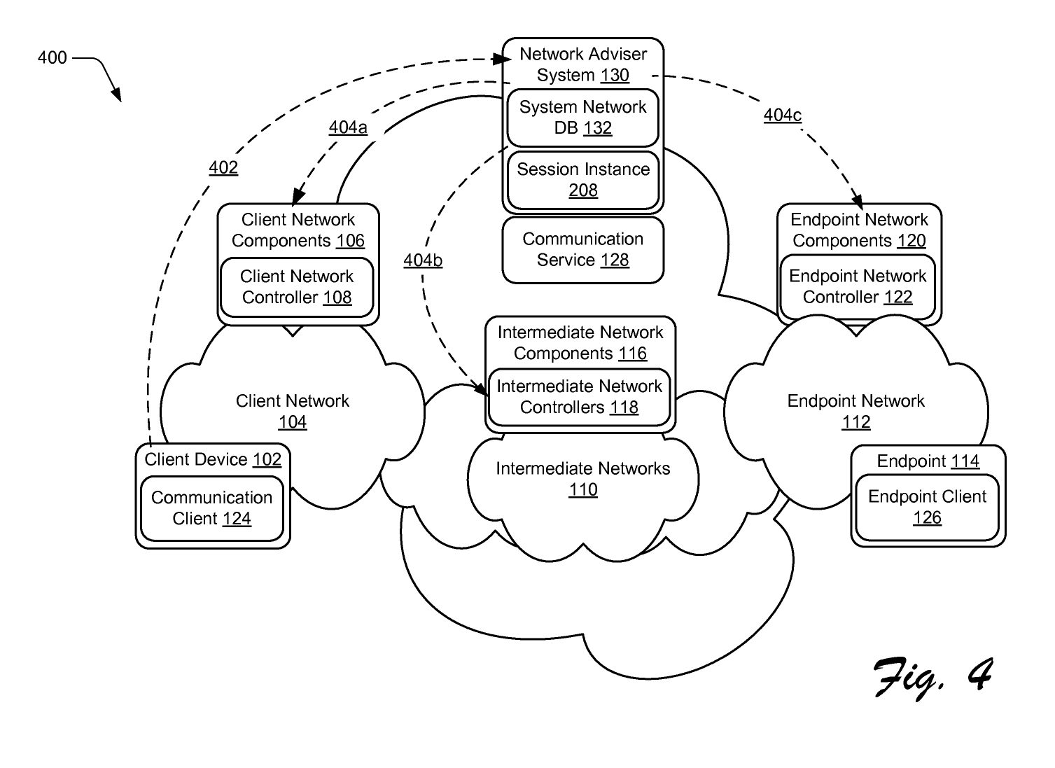

FIG. 4 illustrates an example implementation scenario 300 for propagating session awareness of a session termination in accordance with one or more implementations. The scenario 400 includes various entities and components introduced above with reference to the environment 100. In at least some implementations, the scenario 400 represents an extension of the scenarios 200, 300 discussed above.

In the scenario 400, the communication session 202 is terminated. For instance, a user of the client device 102 selects a functionality to end the communication session 202. Accordingly, the communication client 124 communicates a session termination event 402 to the network adviser system 130. In response to receiving the session termination event 402, the network adviser system 130 notifies various networks involved in the communication session 202 that the communication session is terminated. For instance, the network adviser system 130 communicates an end session event 404a to the client network controller 108, an end session event 404b to the intermediate network controllers 118, and an end session event 404c to the endpoint network controller 122. Generally, the end session events 404a, 404b, 404c notify the respective network controllers that the communication session 202 has been terminated.

In response to receiving the end session events 404a, 404b, 404c, the respective network controllers may perform various actions. For instance, a particular network controller may restore network settings (e.g., a setting of a network component) that was changed to accommodate and/or optimize the communication session 202. As another example, a particular network controller may allocate a network resource that was utilized for the communication session 202 to a different communication session. Various other actions may be performed within the spirit and scope of the implementations discussed herein.

After termination of the communication session 202, the session instance 208 may be stored in the system network DB 132 as a record of various attributes and/or events that occurred during the communication session 202. For instance, the session instance 208 may reflect a timeline of the communication session 202, such as performance attributes of the communication session 202 at specific stages and/or instances of the communication session 202. The session instance 208 may also indicate network performance attributes for particular networks and/or network components that were involved in the communication session 202.

According to various implementations, the session instance 208 may be communicated wholly or in part to the various network controllers that were involved in the communication session 202. Accordingly, the network controllers may utilize information from the session instance 208 to optimize network performance across their respective networks. For instance, a particular network controller may identify from the session instance 208 that a particular network component was a source of a session problem and/or performance degradation during the communication session 202. Accordingly, the particular network controller may perform various actions, such as adjusting settings of the particular network component, routing network traffic around the particular network component, communicating a notification to a network administrator that indicates a problem with the particular network component, and so forth. Thus, the session instance 208 may be leveraged for various purposes to optimize network and/or session performance.

According to various implementations, the system network DB 132 may store session instances for many different communication sessions across multiple different networks. Thus, the system network DB 132 may serve as a repository for historical session performance characteristics that may be referenced to provide network-specific information and attributes. For instance, a particular network controller may query the network adviser system 130 for historical session attributes of communication sessions across a respective network. The network adviser system 130 may search the system network DB 132 for session instances in which the respective network was involved, and may return information from identified session instances to the querying network controller. The network controller may perform various actions based on the information, examples of which are detailed elsewhere herein.

Although the scenarios presented above are discussed with reference to a single communication session 202, it is to be appreciated that the scenarios may be performed for multiple different communication sessions. For instance, the network adviser system 130 may aggregate and propagate session awareness for multiple different communication sessions, and in at least some implementations may do so concurrently.

According to one or more implementations, communication between various entities (e.g., the client device 102, the different network controllers, the endpoint 114, and so forth) and the network adviser system 130 may be implemented via a secure communication procedure, such as using a Transport Layer Security (TLS) protocol. Thus, session awareness may be protected from being access by an unauthorized entity.

Accordingly, the various scenarios and communication events described above may be leveraged to aggregate, disseminate, and store session awareness for communication sessions across a variety of different networks. The network adviser system 130, for example, provides functionality for aggregating and sharing session awareness among autonomous networks involved in routing and/or handling a communication session. In at least some implementations, the various communication events described above can be formatted utilizing various attributes of the communication API detailed in the previous section.

Thus, session awareness of conditions pertaining to communication sessions can be shared among entities involved in routing and/or handling the communication sessions. Such session awareness can be leveraged in various ways, such as for optimizing performance of the communication sessions, mitigating errors that occur and/or may occur in the communication sessions (e.g., session diagnostics), post-session analytics, and so forth.

Having discussed some example implementation scenarios, consider now a discussion of some example procedures in accordance with one or more embodiments.

Example Procedures

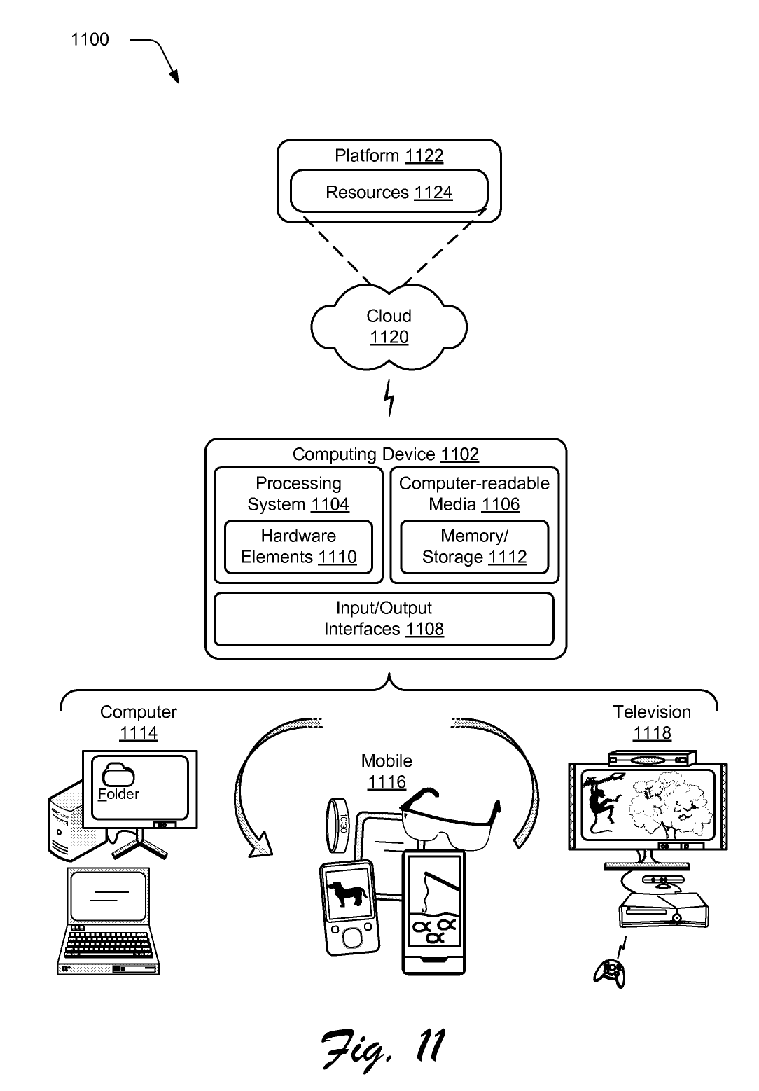

The following discussion describes some example procedures for session awareness for communication sessions in accordance with one or more embodiments. The example procedures may be employed in the environment 100 of FIG. 1, the system 1100 of FIG. 11, and/or any other suitable environment. The procedures, for instance, represent example procedures for implementing the implementation scenarios described above. In at least some embodiments, the steps described for the various procedures can be implemented automatically and independent of user interaction.

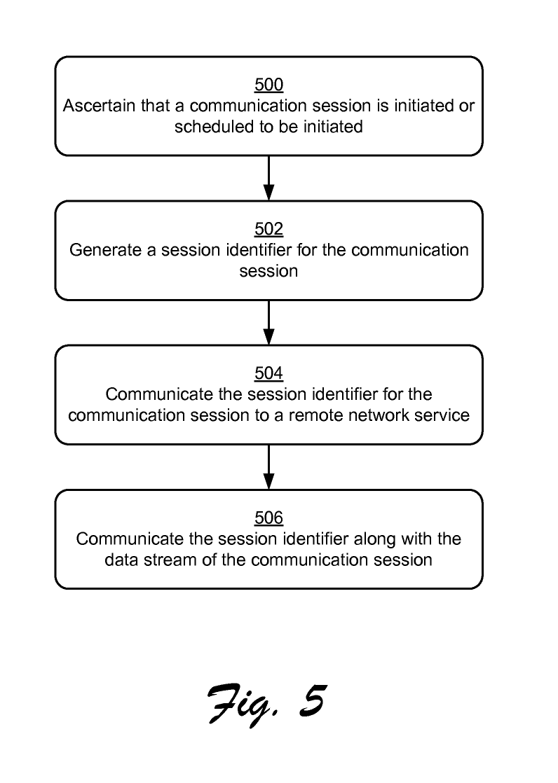

FIG. 5 is a flow diagram that describes steps in a method in accordance with one or more implementations. The method describes an example procedure for causing aggregation of session awareness in accordance with one or more implementations. In at least some implementations, the method may be performed at least in part at the client device 102.

Step 500 ascertains that a communication session is initiated or scheduled to be initiated. Generally, a communication session refers to an exchange of communication media between different communication endpoints. With reference to the environment 100, for example, the client device 102 receives an indication of initiation of the communication session 202, such as via user input to the client device 102. It is to be appreciated, however, that ascertaining that a communication session is initiated and/or scheduled to be initiated can be received in various ways.

In at least some implementations, a scheduled communication session can be detected, such as based on a calendar event that includes a scheduled communication session. For instance, a user can leverage a calendar application on the client device 102 to schedule a calendar event for a future date and time, such as a web meeting, a conference call, a multicast session, and so forth. The user can specify parameters for the calendar event, such as a date and time, users to be invited, types of communication media involved, and so forth. Thus, ascertaining that a communication session is scheduled to be initiated can be based on detecting a calendar event that includes the communication session.

Step 502 generates a session identifier for the communication session. Generally, the session identifier represents a way of differentiating the communication session from other communication sessions, and of enabling various session awareness for the communication session to be aggregated and disseminated.

The session identifier may be generated in various ways, such as a random number that is generated to represent the communication session. As another example, a source IP address, a source communication port (e.g., for the client device 102), a destination IP address, and/or a destination communication port (e.g., for the endpoint 114) may be combined and/or processed in various ways to generate the session identifier.

Step 504 communicates the session identifier for the communication session to a remote network service. The client device 102, for instance, communicates the session identifier 206 to the network adviser system 130. Generally, the session identifier is communicated to the remote network service separately from a data stream of the communication session. Various example ways of communicating a session identifier are detailed above with reference to the example implementation scenarios.

Step 506 communicates the session identifier along with the data stream of the communication session. The client device 102, for example, communicates the session identifier 206 along with a data stream of the communication session 202. Various example ways of communicating a session identifier along with a data stream of a communication session are detailed above with reference to the example implementation scenarios.

According to various implementations, communicating the session identifier along with the data stream of the communication session enables a network component (e.g., a network controller) involved in the communication session to retrieve session awareness information and perform an action based on the session awareness information. The action, for instance, affects the data stream of the communication session, a network involved in the communication session (e.g., network components of a particular network), and so forth. Examples of different actions that may be performed based on session awareness information are discussed below.

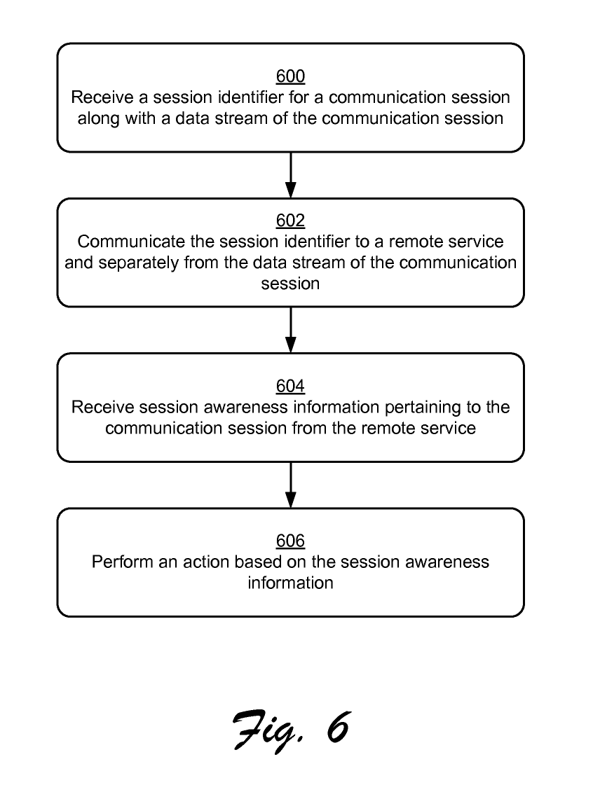

FIG. 6 is a flow diagram that describes steps in a method in accordance with one or more implementations. The method describes an example procedure for receiving session awareness in accordance with one or more implementations. In at least some implementations, the method may be performed at least in part by a network controller and/or other network administrator functionality.

Step 600 receives a session identifier for a communication session along with a data stream of the communication session. A network controller for a particular network, for instance, detects the session identifier in a data stream of a communication session that is communicated through one or more network components of the particular network. Generally, a session identifier may be embedded in and/or associated with a data stream in various ways, examples of which are detailed above. As referenced above, detecting a session identifier may correspond to a triggering event to perform various actions.

Step 602 communicates the session identifier to a remote service and separately from the data stream of the communication session. A network controller, for instance, communicates the session identifier to the network adviser system 130. In at least some implementations, the session identifier may be communicated as part of a query to the remote service for session awareness pertaining to the communication session. Alternatively or additionally, the session identifier on its own may be communicated to the remote service, and the remote service may interpret the session identifier as a request for session awareness.

According to various implementations, the session identifier may be communicated to the network adviser system 130 utilizing an identifier for the network adviser system 130, such as a URI, a URL, and/or other suitable identifier. A particular network controller, for instance, may maintain the identifier for the network adviser system 130. Alternatively or additionally, the identifier may be provided by the client device 102 along with the session identifier 206, e.g., along with the data stream of the communication session 202.

In at least some implementations, communicating the session identifier to the remote service may trigger and/or be part of a validation process for receiving session awareness. A particular network controller, for instance, may participate in a validation process for validating that the network controller is permitted to receive session awareness, e.g., for a particular communication session. One example of such a validation process is discussed below.

Step 604 receives session awareness information pertaining to the communication session from the remote service. The session awareness, for instance, is received separately from the data stream of the communication session. Examples of session awareness are detailed above, and generally include attributes of networks involved in the communication session, attributes of network components, performance attributes for a communication session, and so forth. In at least some implementations, session awareness may include identifiers for users involved in the communication session.

Step 606 performs an action based on the session awareness information. In at least some implementations, the action is performed by a network controller and/or other network component of a network involved in the communication session, such as to optimize performance for the communication session, mitigate session problems, and so forth. For example, the action affects a data stream of the communication session, a network involved in the communication session (e.g., a network component), and so forth.

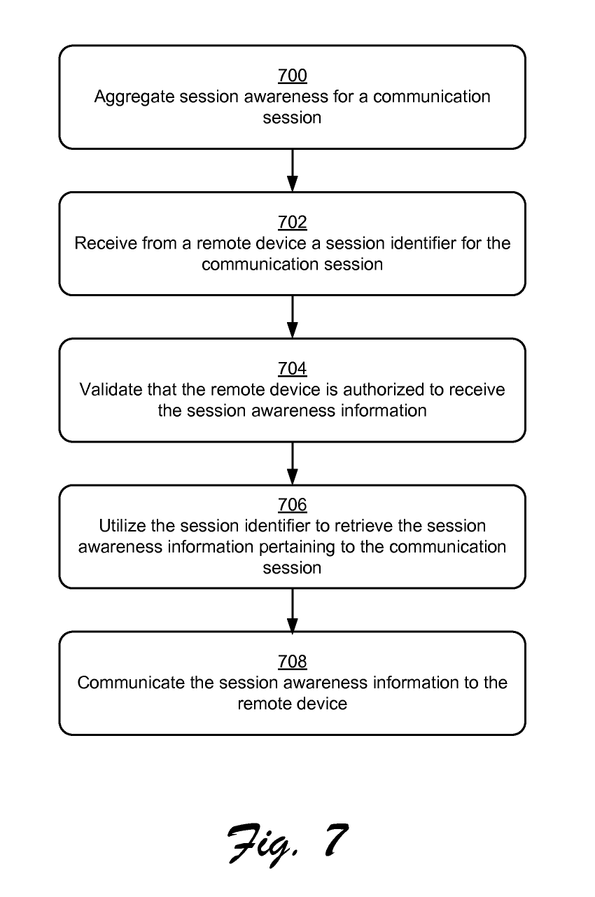

FIG. 7 is a flow diagram that describes steps in a method in accordance with one or more implementations. The method describes an example procedure for aggregating and disseminating session awareness in accordance with one or more implementations. In at least some implementations, the method may be performed at least in part by a network-based service, such as the network adviser system 130.

Step 700 aggregates session awareness pertaining to a communication session. The network adviser system 130, for instance, receives session awareness information from various entities involved in the communication session, such as a network controller and/or other network components. The network adviser system 130 saves the session awareness as part of a session record for the communication session, such as part of the session instance 208.

In at least some implementations, the network adviser system 130 can initiate aggregation of session awareness in response to receiving an indication that a communication session is initiated, such as discussed above with reference to the scenario 200.

Step 702 receives from a remote device a session identifier for the communication session. The session identifier, for instance, is received separately from a data stream of the communication session. For example, with reference to the scenarios described above, the network adviser system 130 receives the session identifier 206 from one or more of the network controllers and separately from a data stream of the communication session 202. In at least some implementations, the network adviser system 130 does not receive and/or have access to the data stream of the communication session 202, but receives intelligence regarding the communication session 202 from network components involved in the communication session 202.

According to one or more implementations, the session identifier is received as part of a query for session awareness for the communication session. Alternatively or additionally, receiving the session identifier itself may be interpreted as a request for session awareness.

Step 704 validates that the remote device is authorized to receive the session awareness information. The network adviser system 130, for example, engages in an authentication procedure to verify an identity of the remote device. Based on the verified identify, the network adviser system 130 determines whether the remote device is permitted to receive session awareness, and if so, what type(s) of session awareness. One example of such a validation process is detailed below.

Step 706 utilizes the session identifier to retrieve the session awareness information pertaining to the communication session. For instance, the network adviser system 130 matches the session identifier to a set of session awareness for the communication session. As discussed above with reference to the example scenarios, the network adviser system 130 may utilize the session instance 208 as an aggregation point for session awareness for the communication session 202. Further, the session instance 208 may be indexed using the session identifier 206. Thus, the session instance 208 may be located using the session identifier 206 such that session awareness may be retrieved from the session instance 208.

Step 708 communicates the session awareness information to the remote device. The session awareness information, for instance, is communicated separately from the data stream of the communication session. Generally, the session awareness information enables the remote device to perform various actions, such as an action that affects the data stream of the communication session, an action that affects a network involved in the communication session, and so forth. Examples of such actions are discussed below.

As discussed above with reference to the example scenarios, session awareness may be communicated to entities involved in a communication session (e.g., a network controller) multiple times and at various stages of a communication session to enable such entities to receive current state information for the communication session.

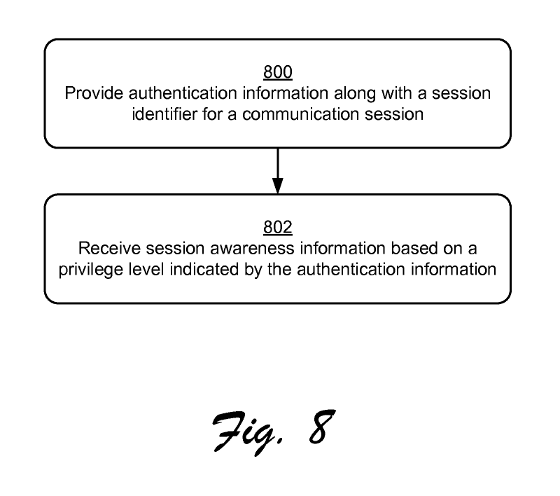

FIG. 8 is a flow diagram that describes steps in a method in accordance with one or more implementations. The method describes an example procedure for verifying access to session awareness in accordance with one or more implementations. In at least some implementations, the method may be performed at least in part by a network controller. The method, for instance, may be performed as part of the procedure discussed above with reference to FIG. 6.

Step 800 provides authentication information along with a session identifier for a communication session. The authentication information, for instance, may include one or more authentication factors that can be used to authenticate an identity of an entity, such as a network controller.

In at least some implementations, the authentication information includes role information describing a role of an entity being authenticated relative to a communication session, such as “client network controller,” “intermediate network controller,” “endpoint network controller,” and so forth. Different roles, for instance, may be entitled to different types and/or collections of session awareness information.

Step 802 receives session awareness information based on a privilege level indicated by the authentication information. The session awareness information, for example, may be received based on a role of the authenticated entity relative to the communication session.

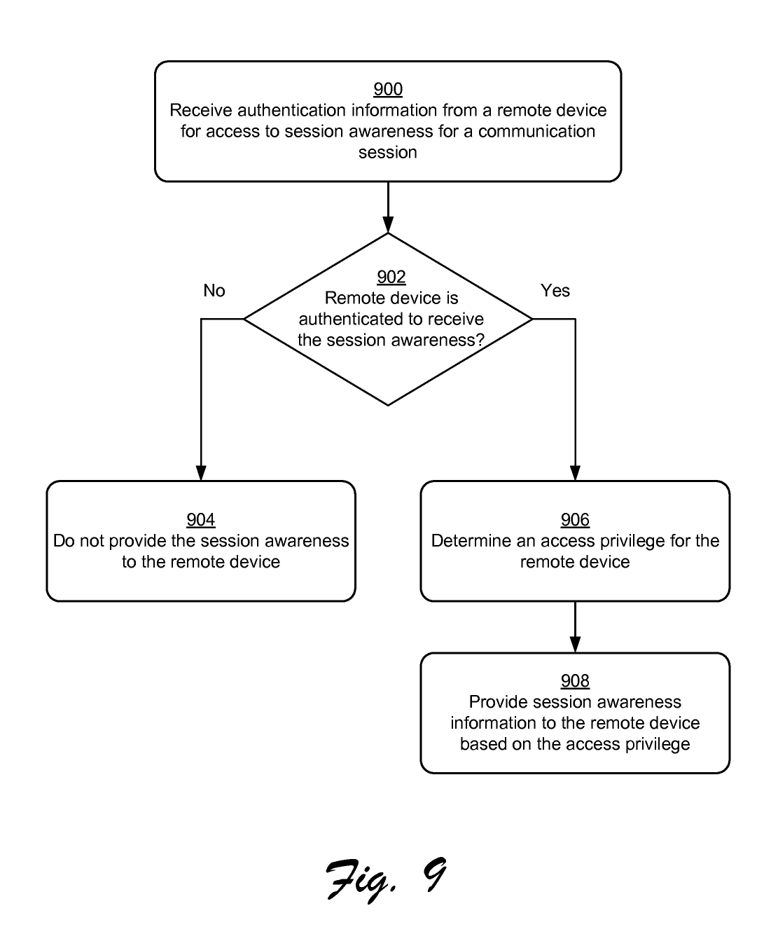

FIG. 9 is a flow diagram that describes steps in a method in accordance with one or more implementations. The method describes an example procedure for allowing access to session awareness in accordance with one or more implementations. In at least some implementations, the method may be performed at least in part by the network adviser system 130. The method, for instance, may be performed as part of the procedure discussed above with reference to FIG. 7.

Step 900 receives authentication information from a remote device for access to session awareness for a communication session. For example, the network adviser system 130 receives the authentication information from a network controller for a network involved in a communication session. The authentication information, for instance, may include one or more authentication factors that can be used to authenticate an identity of an entity, such as a network controller. As referenced above, the authentication information includes role information describing a role of an entity being authenticated relative to a communication session.

Step 902 ascertains whether the remote device is authenticated to receive the session awareness. The network adviser system 130, ascertains whether one or more authentication factors from the authentication information matches a device profile that is permitted to receive the session awareness.

If the remote device is not authenticated to receive the session awareness (“No”), step 904 does not provide the session awareness to the remote device. The network adviser system 130 ascertains, for instance, that the authentication information does not match authentication information for an entity that is permitted to receive the session awareness. In at least some implementations, the network adviser system 130 may communicate a notification to the remote device that the authentication failed and thus the remote device is not permitted to receive the session awareness.

If the remote device is authenticated to receive the session awareness (“Yes”), step 906 determine an access privilege for the remote device. The network adviser system 130, for instance, determines the access privilege based on the authentication information, such as based on a role specified for the remote device. For example, access policies may be defined that specify different access privileges associated with different roles relative to a communication session. As referenced above, different roles may be permitted to access different types and/or collections of session awareness information.

Step 908 provides session awareness information to the remote device based on the access privilege. The network adviser system 130, for instance, identifies session awareness information for the communication session that corresponds to the access privilege. In at least some implementations, the particular access privilege may exclude some session awareness information. The network adviser system 130 communicates the session awareness information to the remote device, e.g., a network controller for a network involved in the communication session.

In at least some implementations, a default network adviser system (e.g., the network adviser system 130) may be considered untrusted by a particular entity involved in a communication session. For instance, the network adviser system 130 may be unknown to the endpoint 114, and thus untrusted by the endpoint 114. Thus, according to one or more implementations, a procedure may be provided for negotiating for a trusted network adviser. Consider, for example, the following procedure.

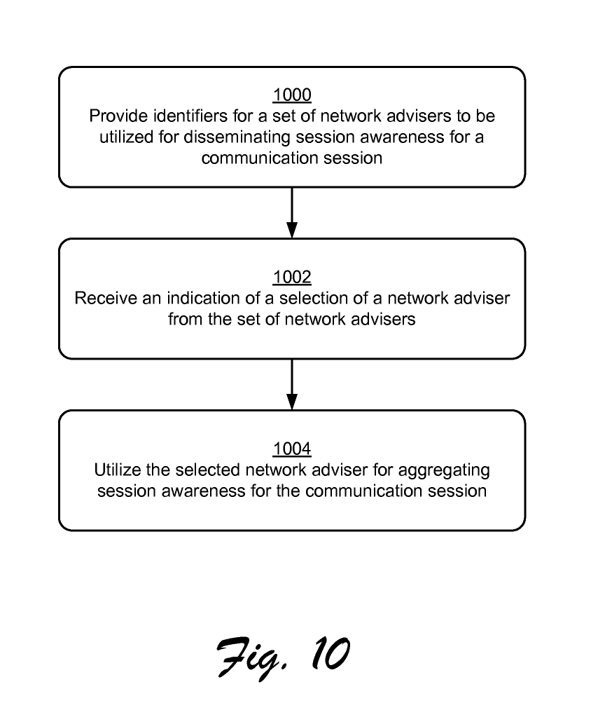

FIG. 10 is a flow diagram that describes steps in a method in accordance with one or more implementations. The method describes an example procedure for negotiating for a trusted network adviser in accordance with one or more implementations. In at least some implementations, the method may be performed at least in part via communication between the client device 102 and the endpoint 114. The method, for instance, may be performed as part of the example implementation scenarios described above.

Step 1000 provides identifiers for a set of network advisers to be utilized for disseminating session awareness for a communication session. The client device 102, for example, communicates a list of available network advisers (e.g., including the network adviser system 130) to one or more parties involved in a communication session. For instance, the client device 102 communicates the list of available network advisers to the endpoint 114.

Step 1002 receives an indication of a selection of a network adviser from the set of network advisers. For example, the client device 102 receives an indication that the endpoint 114 selects a particular network adviser (e.g., the network adviser system 130) from the set of network advisers.

Step 1004 utilizes the selected network adviser for aggregating session awareness for the communication session. The client device 102, for instance, can communicate an identifier for the selected network adviser to network components involved in the communication session, such as to network controllers for networks that the communication session traverses. For example, the identifier for the selected network adviser may be communicated along with a session identifier. Thus, the different network components can utilize the identifier to communicate session awareness to the selected network adviser, and to receive session awareness from the selected network adviser.

According to various implementations, the methods described above may be performed multiple times at various stages of a communication session, such as prior to session initiation, concurrent with session initiation, during a communication session, at session termination, and post communication session. For instance, session awareness of a communication session can be propagated and updated in real-time while the communication session is in progress to maintain dynamic and active state awareness of conditions that may affect the communication session.

Session awareness of a communication session may also be proactively communicated prior to initiation of the communication session, such as to enlighten autonomous networks of the upcoming communication session and enable the autonomous networks to make adjustments and/or preparations to accommodate the communication session. Session awareness of a communication session may also be communicated after termination of the communication session, such as for system diagnostics and statistical analysis of network performance that occurred during the communication session.

Thus, techniques discussed herein provide a wide variety of scenarios and implementations for propagating session awareness to different entities involved in routing communication sessions. Session awareness enables such entities to make informed decisions regarding routing and handling of communication session data.

Having discussed some example procedures, consider now a discussion of some example actions that can be taken based on session awareness in accordance with one or more implementations.

Example Actions Based on Session Awareness

This section describes some example actions that may be performed based on session awareness. The actions, for instance, represent example actions discussed above with reference to the example implementation scenarios and the example procedures.

(1) Stream routing decisions internal to each network—a network component can leverage session awareness to make various stream routing decisions for routing of a communication session within its respective network. Such stream routing decisions include routing a communication session through a particular network component, rerouting away from a particular component (e.g., a component that has performance problems), and so forth. A stream routing decision may also include routing and/or rerouting to a different adjacent network, such as in response to session awareness that indicates that a current network through which a communication session is routed is experiencing a technical problem and/or is causing session performance degradation.

(2) Coordinated global routing decisions—a network component can leverage session awareness to negotiate with network components of other networks to make routing decisions that affect multiple networks that a communication session traverses.

(3) Changing local configuration for stream prioritization—a network component can leverage session awareness to change a data stream priority for a communication session that traverses its respective network. For instance, the data stream priority can be increased, decreased, and so forth.

(4) Adjust the network for QoS markings—a network component can leverage session awareness to adjust QoS markings that are applied to a data stream of a communication session. For instance, the session awareness can specify a preferred QoS marking for the data stream, which the network component can use to replace and/or override a current QoS marking for the data stream.

(5) Provide feedback regarding the network state—a network component can leverage session awareness to provide feedback to various entities regarding network state, such as to indicate session performance for a communication session in a respective network. In at least some implementations, the feedback can be provided to a user involved in a communication session and/or involved in a network, such as an end user, an administrator, information technology (IT) personnel, and so forth.

(6) Subscription information—a network component can leverage session awareness to apply subscription information to aspects of a communication session. For instance, session awareness may indicate that a user involved in a communication session is a premium user (e.g., has a paid subscription) and thus is entitled to an increased service level. The increased service level may provide various optimizations, such as increased bandwidth, a higher QoS, additional communication channels, and so forth.

(7) Session analytics—a network component can leverage session awareness for session analytics, such as to analyze and record network performance, component performance, and so forth, as part of a communication session.

(8) Resource allocation—a network component can leverage session awareness to allocate and/or request additional resources for a communication session. For instance, a network component can request additional resources (e.g., an additional channel) within its own respective network, and/or can communicate with a different network along a routing path of a communication session to request that the different network allocate additional resources to the communication session. Generally, allocation of additional resources may increase quality of a communication session, such as by increasing bandwidth, reducing errors, and so forth.

Having discussed some example actions that can be performed based on session awareness, consider now a discussion of an example system and device in accordance with one or more embodiments.

Example System and Device

FIG. 11 illustrates an example system generally at 1100 that includes an example computing device 1102 that is representative of one or more computing systems and/or devices that may implement various techniques described herein. For example, the client device 102, the endpoint 114, and/or the network adviser system 130 discussed above with reference to FIG. 1 can be embodied as the computing device 1102. The computing device 1102 may be, for example, a server of a service provider, a device associated with the client (e.g., a client device), an on-chip system, and/or any other suitable computing device or computing system.

The example computing device 1102 as illustrated includes a processing system 1104, one or more computer-readable media 1106, and one or more Input/Output (I/O) Interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware element 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone (e.g., for voice recognition and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “entity,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media.

As previously described, hardware elements 1110 and computer-readable media 1106 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of modules that are executable by the computing device 1102 as software may be achieved at least partially in hardware, e.g., through use of computer-readable storage media and/or hardware elements 1110 of the processing system. The instructions and/or functions may be executable/operable by one or more articles of manufacture (for example, one or more computing devices 1102 and/or processing systems 1104) to implement techniques, modules, and examples described herein.

As further illustrated in FIG. 11, the example system 1100 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1100, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 1102 may assume a variety of different configurations, such as for computer 1114, mobile 1116, and television 1118 uses. Each of these configurations includes devices that may have generally different constructs and capabilities, and thus the computing device 1102 may be configured according to one or more of the different device classes. For instance, the computing device 1102 may be implemented as the computer 1114 class of a device that includes a personal computer, desktop computer, a multi-screen computer, laptop computer, netbook, and so on.

The computing device 1102 may also be implemented as the mobile 1116 class of device that includes mobile devices, such as a mobile phone, portable music player, portable gaming device, a tablet computer, a wearable device, a multi-screen computer, and so on. The computing device 1102 may also be implemented as the television 1118 class of device that includes devices having or connected to generally larger screens in casual viewing environments. These devices include televisions, set-top boxes, gaming consoles, and so on.

The techniques described herein may be supported by these various configurations of the computing device 1102 and are not limited to the specific examples of the techniques described herein. For example, functionalities discussed with reference to the communication service 128 and/or the network adviser system 130 may be implemented all or in part through use of a distributed system, such as over a “cloud” 1120 via a platform 1122 as described below.

The cloud 1120 includes and/or is representative of a platform 1122 for resources 1124. The platform 1122 abstracts underlying functionality of hardware (e.g., servers) and software resources of the cloud 1120. The resources 1124 may include applications and/or data that can be utilized while computer processing is executed on servers that are remote from the computing device 1102. Resources 1124 can also include services provided over the Internet and/or through a subscriber network, such as a cellular or Wi-Fi network.

The platform 1122 may abstract resources and functions to connect the computing device 1102 with other computing devices. The platform 1122 may also serve to abstract scaling of resources to provide a corresponding level of scale to encountered demand for the resources 1124 that are implemented via the platform 1122. Accordingly, in an interconnected device embodiment, implementation of functionality described herein may be distributed throughout the system 1100. For example, the functionality may be implemented in part on the computing device 1102 as well as via the platform 1122 that abstracts the functionality of the cloud 1120.

Discussed herein are a number of methods that may be implemented to perform techniques discussed herein. Aspects of the methods may be implemented in hardware, firmware, or software, or a combination thereof. The methods are shown as a set of steps that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

Implementations discussed herein include:

1. An example system including: at least one processor; and one or more computer-readable storage media including instructions stored thereon that, responsive to execution by the at least one processor, cause the system perform operations including: receiving a session identifier for a communication session along with a data stream of the communication session; communicating the session identifier to a remote service and separately from the data stream of the communication session; receiving session awareness information pertaining to the communication session from the remote service separately from the data stream of the communication session; and performing an action based on the session awareness information, the action including attempting to optimize performance of at least one of the data stream of the communication session or a network involved in the communication session.

2. The example system 1, wherein the operations further include communicating one or more attributes of the network involved in the communication session to the remote service.

3. The example system of any of the preceding examples 1 or 2, wherein the operations further include communicating one or more performance attributes of the communication session to the remote service.

4. The example system of any of the preceding examples 1-3, wherein the operations further include participating in a validation process with the remote service to validate permission to receive the session awareness information.

5. The example system of any of the preceding examples 1-4, wherein the operations further include, prior to receiving the session awareness information, communicating authentication information to the remote service to validate permission to access to the session awareness information.

6. The example system of any of the preceding examples 1-5, wherein the operations further include, prior to receiving the session awareness information, communicating role information to the remote service, the role information describing a role of an entity involved in the communication session and being usable to ascertain a permission level for access to the session awareness information.

7. The example system of any of the preceding examples 1-6, wherein the system includes a network component of the network involved in the communication session, and wherein the session awareness information includes attributes of one or more other networks involved in the communication session.

8. The example system of any of the preceding examples 1-7, wherein the operations further include: receiving an indication of a change in a state of one or more of the communication session or the network involved in the communication session; and communicating an indication of the change in the state to the remote service.

9. The example system of any of the preceding examples 1-8, wherein the action includes reconfiguring a routing attribute of the communication session in the network involved in the communication session.

10. The example system of any of the preceding examples 1-9, wherein the action includes communicating with one or more other networks involved in the communication session to attempt to optimize performance of the data stream of the communication session.

11. The example system of any of the preceding examples 1-10, wherein the action includes changing a quality of service marking for the data stream of the communication session.

12. An example computer-implemented method, including: receiving from a remote device a session identifier for a communication session, the session identifier being received separately from a data stream of the communication session; validating that the remote device is authorized to receive session awareness information pertaining to the communication session; and communicating the session awareness information to the remote device, the session awareness information being communicated separately from the data stream of the communication session and enabling the remote device to perform an action to optimize at least one of the data stream of the communication session or a network involved in the communication session.

13. The example system of the preceding example 12, further including, prior to said receiving, aggregating the session awareness from multiple different networks involved in the communication session.

14. The example system of any of the preceding examples 12 or 13, further including, prior to said receiving: aggregating the session awareness from multiple different networks involved in the communication session; and storing the session awareness as part of a session instance that maintains dynamic state attributes for one or more of the communication session or the multiple networks involved in the communication session.

15. The example system of any of the preceding examples 12-14, wherein the session awareness includes performance attributes for one or more of the communication session or the network involved in the communication session.

16. The example system of any of the preceding examples 12-15, further including selecting the session awareness to communicate to the remote device based on a role of the remote device relative to the communication session.

17. The example system of any of the preceding examples 12-16, further including selecting the session awareness to communicate to the remote device based on a permission level of the remote device for access to the session awareness.

18. The example system of any of the preceding examples 12-17, further including: receiving an indication of a change in a state of one or more of the communication session or the network involved in the communication session; and communicating a notification event to the remote device indicating the change in the state.

19. An example computer-implemented method, including: ascertaining that a communication session is initiated or scheduled to be initiated; communicating a session identifier for the communication session to a remote network service, the session identifier being communicated to the remote network service separately from a data stream of the communication session; and communicating the session identifier along with the data stream of the communication session to enable a network component involved in the communication session to retrieve session awareness information and perform an action based on the session awareness information, the action affecting at least one of the data stream of the communication session or a network involved in the communication session.

20. The example method 1, further including identifying the remote network service via a negotiation process for identifying a trusted remote network service.

Conclusion

Techniques for session awareness for communication sessions are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

What is claimed is:

1. A system comprising:
at least one processor; and
one or more computer-readable storage media including instructions stored thereon that, responsive to execution by the at least one processor, cause the system perform operations including:
receiving a session identifier for a communication session along with a data stream of the communication session;
communicating the session identifier to a remote service and separately from the data stream of the communication session;
receiving session awareness information pertaining to the communication session from the remote service separately from the data stream of the communication session; and
performing an action based on the session awareness information, the action including attempting to optimize performance of at least one of the data stream of the communication session or a network involved in the communication session.

2. A system as recited in claim 1, wherein the operations further include communicating one or more attributes of the network involved in the communication session to the remote service.

3. A system as recited in claim 1, wherein the operations further include communicating one or more performance attributes of the communication session to the remote service.

4. A system as recited in claim 1, wherein the operations further include participating in a validation process with the remote service to validate permission to receive the session awareness information.

5. A system as recited in claim 1, wherein the operations further include, prior to receiving the session awareness information, communicating authentication information to the remote service to validate permission to access to the session awareness information.

6. A system as recited in claim 1, wherein the operations further include, prior to receiving the session awareness information, communicating role information to the remote service, the role information describing a role of an entity involved in the communication session and being usable to ascertain a permission level for access to the session awareness information.

7. A system as recited in claim 1, wherein the system comprises a network component of the network involved in the communication session, and wherein the session awareness information includes attributes of one or more other networks involved in the communication session.

8. A system as recited in claim 1, wherein the operations further include:
receiving an indication of a change in a state of one or more of the communication session or the network involved in the communication session; and
communicating an indication of the change in the state to the remote service.

9. A system as recited in claim 1, wherein the action includes reconfiguring a routing attribute of the communication session in the network involved in the communication session.

10. A system as recited in claim 1, wherein the action includes communicating with one or more other networks involved in the communication session to attempt to optimize performance of the data stream of the communication session.

11. A system as recited in claim 1, wherein the action includes changing a quality of service marking for the data stream of the communication session.

12. A computer-implemented method, comprising:
receiving from a remote device a session identifier for a communication session, the session identifier being received separately from a data stream of the communication session;
validating that the remote device is authorized to receive session awareness information pertaining to the communication session; and
communicating the session awareness information to the remote device, the session awareness information being communicated separately from the data stream of the communication session and enabling the remote device to perform an action to optimize at least one of the data stream of the communication session or a network involved in the communication session.

13. A method as described in claim 11, further comprising, prior to said receiving, aggregating the session awareness from multiple different networks involved in the communication session.

14. A method as described in claim 11, further comprising, prior to said receiving:
aggregating the session awareness from multiple different networks involved in the communication session; and
storing the session awareness as part of a session instance that maintains dynamic state attributes for one or more of the communication session or the multiple networks involved in the communication session.

15. A method as described in claim 11, wherein the session awareness includes performance attributes for one or more of the communication session or the network involved in the communication session.

16. A method as described in claim 11, further comprising selecting the session awareness to communicate to the remote device based on a role of the remote device relative to the communication session.

17. A method as described in claim 11, further comprising selecting the session awareness to communicate to the remote device based on a permission level of the remote device for access to the session awareness.

18. A method as described in claim 11, further comprising:
receiving an indication of a change in a state of one or more of the communication session or the network involved in the communication session; and
communicating a notification event to the remote device indicating the change in the state.

19. A computer-implemented method, comprising:
ascertaining that a communication session is initiated or scheduled to be initiated;
communicating a session identifier for the communication session to a remote network service, the session identifier being communicated to the remote network service separately from a data stream of the communication session; and
communicating the session identifier along with the data stream of the communication session to enable a network component involved in the communication session to retrieve session awareness information and perform an action based on the session awareness information, the action affecting at least one of the data stream of the communication session or a network involved in the communication session.

20. A method as described in claim 19, further comprising identifying the remote network service via a negotiation process for identifying a trusted remote network service.
